(19) United States
(12) Patent Application Publication
(10) Pub. No.: US 2006/0170322 A1
(43) Pub. Date: Aug. 3, 2006

(54) Circuit electron emission element, method of manufacturing electron emission element, image display device, and electronic apparatus

(75) Inventor: Hirofumi Yasuda, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/319,076

(22) Filed: Dec. 27, 2005

(30) Foreign Application Priority Data
Jan. 31, 2005 (JP) 2005-022680

(51) Int. Cl. H01J 9/02

(52) U.S. Cl. 313/310

(57) ABSTRACT

An electron emission element includes: a pair of electrodes facing each other with a predetermined gap therebetween; a conductive thin film which bridges across the electrodes and has a narrow region in which a part of at least one side of two sides of an area bridging across the electrodes is close to the other side; and an electron emission section formed in the narrow region of the conductive thin film. In here, the narrow region is narrower than the width between the electrodes in a direction orthogonal to a direction where the electrodes face each other.

### BACKGROUND

1. Technical Field

The present invention relates to an electron emission element formed by a droplet discharge method, to a method of manufacturing the electron emission element, to an image display device, and to an electronic apparatus.

2. Related Art

The electron emission elements are typically classified into a thermoelectronic emission element and a cold cathode electron emission element in the related art. The cold cathode electron emission element includes a field emission type, a surface conductive type, and so forth.

According to an example of the method of manufacturing the surface conduction electron emission element, a convex portion is formed between opposing electrodes on a substrate, and a droplet of a solution containing a conductive thin film formation material is discharged between the electrodes by an inkjet method so as to cover the convex portion, so that the conductive thin film is formed. Further, according to another example, a concave portion is formed in the substrate and/or the electrode so as to be positioned in a peripheral portion of an area where the droplet is discharged, and a droplet of a solution containing the conductive thin film formation material is discharged between the electrodes by the inkjet method to form the conductive thin film. However, in both the above-mentioned methods, the conductive thin film is locally broken, deformed or changed by electrically connecting between the electrodes (referred to as electrical connection) to form an electron emission unit which is in an electrically high resistant state (see JP-A-10-12135).

FIGS. 10 and 11 show examples of the surface conduction electron emission element manufactured by the above-described method. FIGS. 9A and 9B show an example of an electron emission element 80 having a convex portion 86 between the opposing electrodes 82 and 83 on a substrate 81 according to the one example, and FIGS. 10A and 10B show another example of an electron emission element 90 having concave portions 96 in electrodes 92 and 93 according to the another example.

The above methods is to prevent that the thickness of the conductive thin film 84 on the convex portion 86 becomes thinner than its adjacent portions as shown in FIGS. 9A and 9B, which makes it difficult to cause electron emission due to the excessive thickness of the convex portion. In addition, as shown in FIGS. 10A and 10B, the method is to prevent the case when the solution containing the conductive thin film formation material is flown into the concave portion 96, which makes the thickness near the center of the droplet excessively large. That is, the method is aimed to form the electron emission sections 85 and 95 by making the thicknesses of the conductive thin films 84 and 94 more uniform so as to electrically connect to each other.

However, according to the method of manufacturing the electron emission element of the related art, when the droplet of the solution containing the conductive thin film formation material is discharged by an inkjet method, the shape of the droplet is determined by its surface tension or wettability of the substrate, and its cross-sectional shape becomes a circular arc. In addition, the shape or the thickness depends on the subsequent dry condition. Accordingly, the variation in the electron emission property occurs due to the non-uniformity of the conductive thin film, and it is difficult to form the electron emission section with high positional accuracy in a consistent direction by means of electrical connection.

In addition, when a plurality of electron emission elements manufactured by the manufacturing method of the related art are arranged and fluorescent substances facing the respective electron emission elements are arranged so as to manufacture an image display device, non-uniformity in the light emission of the fluorescent substances occurs due to the irregularities of positions where the respective electron emission sections are arranged.

### SUMMARY

An advantage of some aspects of the invention is to provide an electron emission element having an electron emission section in a stable position while having a stable electron emission property, a method of manufacturing the electron emission element, and an image display device and an electronic apparatus using the electron emission element.

A first aspect of the invention provides an electron emission element, which includes: a pair of electrodes facing each other with a predetermined gap therebetween; a conductive thin film which bridges across the electrodes and has a narrow region in which a part of at least one side of two sides of an area bridging across the electrodes is close to the other side; and an electron emission section formed in the narrow region of the conductive thin film. In this case, the narrow region is narrower than the width between the electrodes in a direction orthogonal to a direction where the electrodes face each other.

According to this aspect, the conductive thin film bridging across the pair of electrodes facing each other with a predetermined gap therebetween on the substrate, has the narrow region in which a part of at least one side of two sides of an area bridging across the electrodes is close to the other side. The position of the electron emission section formed by the electrical connection depends on the resistance between the electrodes at the time of electrical connecting. The resistance between the electrodes is determined by an interval between two sides of the conductive thin film in the direction crossing the electrodes when the thickness of the conductive thin film of the area bridging across the electrodes is constant. The narrow region of the conductive thin film is narrower than the width of the electrode in the direction orthogonal to the direction where the electrodes face each other. Accordingly, the narrow region of the conductive thin film bridging across the pair of electrodes has the highest resistance. Since the electron emission section is formed in the narrow region, the electron emission element can be provided in which the electron emission section is formed in the stable position corresponding to the narrow region of the conductive thin film.

The conductive thin film preferably has the narrow region such that the part of at least the one side of two sides of the area bridging across the electrodes is a circular arc and the arced side is close to the other side.

According to this aspect, the narrow region in which the arced part of at least one of two sides of the conductive thin film in the area bridging across the electrodes is close to the other side, has a smaller width than the width between other portions of the conductive thin film in the direction orthogonal to the direction where the electrodes face each other. Accordingly, a leakage current does not occur at the time of electrical connecting, so that the electron emission element having the electron emission section formed in a more stable position can be provided.

A second aspect of the invention provides a method of manufacturing an electron emission element, which includes: forming a pair of electrodes facing each other with a predetermined gap therebetween on a substrate; forming a conductive thin film that bridges across the electrodes; partially removing the conductive thin film so that a part of at least one side of two sides of an area bridging across the electrodes is a circular arc, and a narrow region in which the part of the arced side is close to the other side is narrower than the width between the electrodes in a direction orthogonal to a direction where the electrodes face each other; and electrically connecting between the electrodes to form an electron emission section in the conductive thin film.

According to this method, the part of the conductive thin film is removed such that at least one side of two sides of the conductive thin film in an area bridging across the electrodes becomes a circular arc while the narrow region in which the arced side of the at least one side is close to the other side is narrower than the width between the electrodes in the direction orthogonal to the direction where the electrodes face each other. Accordingly, the conductive thin film is partially removed even when the thickness of the peripheral portion is changed before removing process, so that the narrow region has the uniform thickness in the area bridging across the electrodes and has a high resistance. Thereafter, the electrodes are electrically connected in the step of forming the electron emission section, so that the electron emission section can be easily formed by breaking, deforming, or changing the narrow region having the uniform thickness and the high resistance. That is, the variation in the electron emission property due to the non-uniformity of the conductive thin film can be reduced while the electron emission element having the electron emission section formed in a stable position and corresponding to the narrow region of the conductive thin film can be manufactured.

In the removing process, the removing of the conductive thin film preferably includes etching the conductive thin film by discharging an etchant to the peripheral portion of at least one side between two sides of the conductive thin film in the area bridging across the electrodes.

According to this method, the etchant discharged so as to bridge across at least one side between two sides of the conductive thin film in the area bridging across the electrodes becomes approximately circular because of its surface tension to etch the conductive thin film when seen in plan view. Therefore, the conductive thin film can be partially removed as circular shapes. In addition, the conductive thin film can be partially etched as circular shapes in a more simplified process than a case of etching the conductive thin film in a photolithography manner.

In addition, the forming of the conductive thin film preferably includes discharging a functional solution containing a conductive thin film formation material.

According to this method, in the thin film forming process, the functional solution containing the conductive thin film formation material is discharged to form the conductive thin film, so that the conductive thin film can be formed by a more simplified method than the method forming the conductive thin film by using the vacuum such as a deposition method or a sputtering method. In addition, when the method is combined with a method of discharging the etchant to etch the conductive thin film, it is possible to continuously perform from the thin film forming process to the etching process, and to more effectively manufacture the element emission element.

A third aspect of the invention provides an image display device, which includes: an electron emission element described in the first aspect; and a fluorescent substance which receives electrons emitted from the electron emission element to emit light.

According to this aspect, the image display device has a stable electron emission property while including the electron emission element having the electron emission section formed in a stable position, so that the fluorescent substance emits light by means of electrons emitted from the electron emission element, so that the image display device having a high display quality and reduced display defects such as luminance irregularities can be manufactured.

A fourth aspect of the invention provides a method of manufacturing an image display device including an electron emission element and a fluorescent substance that receives electrons emitted from the electron emission element to emit light, and the method includes manufacturing the electron emission element by a method described in the third aspect.

According to this method, the electron emission element is manufactured by the method of manufacturing the electron emission element, so that the image display device can be manufactured which has a stable electron emission property and includes the electron emission element having the electron emission section formed in a stable position. Accordingly, the fluorescent substance emits light by means of electrons emitted from the electron emission element, so that the image display device having a high display quality and less display defects such as luminance variation can be manufactured.

An electronic apparatus of another aspect of the invention has the image display device of the above-described aspect mounted. As such, the electronic apparatus has the above-described image display device mounted, the electronic apparatus can be provided which can check input and output information with a high display quality and reduced display defects such as luminance irregularities.

### BRIEF DESCRIPTION OF THE DRAWINGS

The invention will be described with reference to the accompanying drawings, wherein like numbers reference like elements.

FIG. 1A is a schematic plan view illustrating a structure of an electron emission element.

FIG. 1B is a cross-sectional view illustrating an electron emission element taken along the line IA-IA of FIG. 1A.

FIG. 2 is a flow chart illustrating a method of manufacturing an electron emission element.

FIG. 3 is a schematic perspective view illustrating a structure of a droplet discharge head.

FIGS. 4A to 4F are schematic cross-sectional views illustrating a method of manufacturing an electron emission element corresponding to the flow chart.

FIG. 5A is a schematic cross-sectional view illustrating a main structure of an image display device.

FIG. 5B is a schematic plan view illustrating an arrangement of an electron emission element on an element substrate.

FIG. 6 is a schematic perspective view illustrating a portable digital assistant as an electronic apparatus.

FIG. 7 is a schematic plan view illustrating an electron emission element according to a modified embodiment.

FIG. 8 is a schematic plan view illustrating an electron emission element according to another modified embodiment.

FIG. 9A is a schematic plan view illustrating an example of an electron emission element.

FIG. 9B is a schematic cross-sectional view illustrating the example of the electron emission element.

FIG. 10A is a schematic plan view illustrating another example of an electron emission element.

FIG. 10B is a schematic cross-sectional view illustrating the example of the electron emission element.

### DESCRIPTION OF EXEMPLARY EMBODIMENTS

An electron emission element according to an embodiment of the invention will be first described with reference to the accompanying drawings. In this case, the electron emission device of the present embodiment is a surface conductive type in which a conductive thin film having the electron emission part is formed by discharging a functional solution containing a conductive thin film formation material onto the substrate.

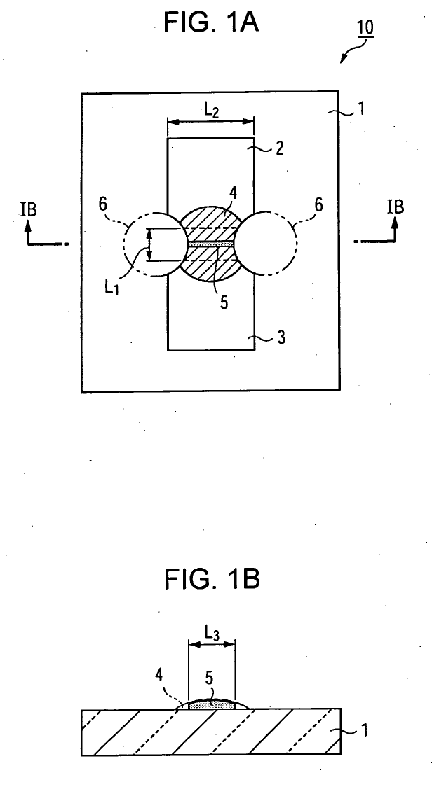

FIG. 1 is a schematic view illustrating a structure of an electron emission element. To detail this, FIG. 1A is a schematic plan view thereof, and FIG. 1B is a schematic cross-sectional view taken along the line IB-IB of FIG. 1A.

As shown in FIG. 1A, the electron emission element 10 of the present embodiment includes a pair of element electrodes 2 and 3 facing each other with a predetermined gap L₁ therebetween on an element substrate 1, a conductive thin film 4 bridging across the element electrodes 2 and 3, having two sides of circular arcs facing each other in an area bridging across the element electrodes 2 and 3 and having a narrow region in which a part of one side between the two sides is close to the other side, and an electron emission section 5 formed in the narrow region of the conductive thin film 4.

An insulating substrate composed of a transparent glass substrate or a ceramic may be used as the element substrate 1.

A metal such as Au, Mo, W, Pt, Ti, Al, Cu, Pd, Ni, Cr, an alloy thereof, or an Indium Tin Oxide (ITO) may be used as the element electrodes 2 and 3. The thickness may be several hundreds nm to several μm.

A metal such as Pd, Pt, Ti, Ru, In, Cu, Cr, Ag, Au, Fe, Zn, Sn, Ta, W, Pb, an oxide such as PdO, SnO₂, In₂O₃, PbO, Sb₂O₃, a boride such as HfB₂, ZrB₂, LaB₆, CeB₆, YB₄, GdB₄, a carbide such as TiC, ZrC, HfC, TaC, SiC, WC, a nitride such as TiN, ZrN, HfN, a semiconductor such as Si, Ge, and carbon may be used for forming the conductive thin film 4. The thickness may be several 10^{⊕1} nm to several hundreds nm.

The conductive thin film 4 is formed by discharging a functional solution containing the above-described conductive thin film formation material between the element electrodes 2 and 3. In this case, after the functional solution is landed, the sectional shape thereof becomes a circular arc due to the surface tension. Further, even after the conductive thin film 4 becomes thinner by means of drying and baking, a thin portion and a thick portion exist in the IB-IB section as shown in FIG. 1B. Accordingly, two sides of the conductive thin film in an area bridging across the element electrodes 2 and 3 are etched to be circular arcs as shown in FIG. 1A. As a result, the conductive thin film 4 has a narrow region in which the arced sides face each other and a part of one side is close to the other side in a direction orthogonal to a direction where the element electrodes 2 and 3 face each other. Accordingly, the thickness of the conductive thin film 4 in the peripheral region of the emission discharge section 5 formed in the narrow region can be made to be uniform as compared to a case prior to etching. In addition, the width L₃ of the narrow region is smaller than the width L₂ in the direction orthogonal to the direction where the pair of element electrodes 2 and 3 face each other.

In addition, when the functional solution containing a small amount of the conductive thin film is discharged onto the element substrate 1 and then dried and baked to be thin, the conductive thin film 4 having a thick peripheral portion is formed. Accordingly, when parts of two sides bridging across the element electrodes 2 and 3 of the conductive thin film 4 are etched to be circular arcs, parts of the thick sides are removed to form the narrow region. Therefore, the thickness of the conductive thin film 4 in the peripheral region of the electron emission section 5 formed in the narrow region can be made to be more uniform as compared to a case prior to etching.

Further, in this case, since the width L₃ of the narrow region is smaller than the width L₂ of the direction orthogonal to the direction where the element electrodes 2 and 3 face each other, the resistance between the element electrodes 2 and 3 become high in the narrow region. Accordingly, the electron emission section 5 is formed at a position corresponding to the narrow region of the conductive thin film 4 by electrically connecting the electrodes. The electrical connection method will be described later. Method of manufacturing the electron emission element

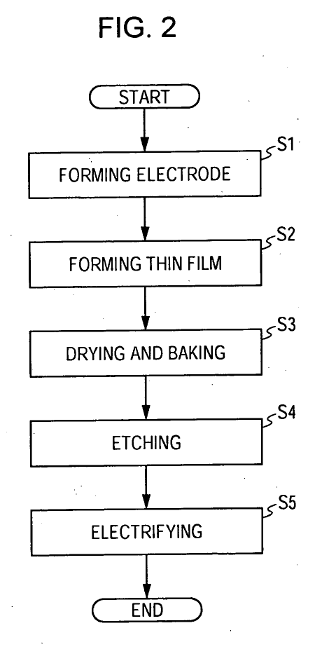

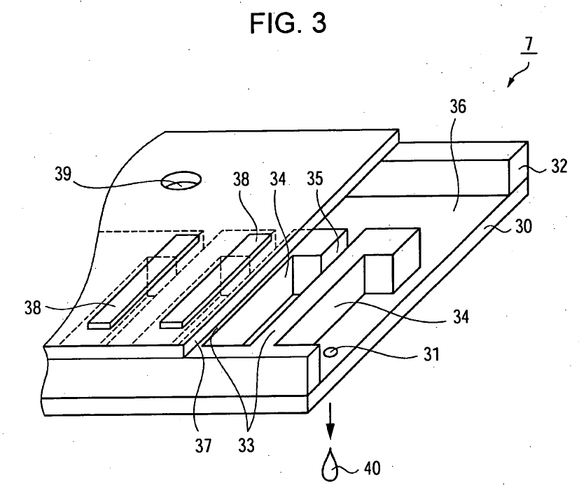

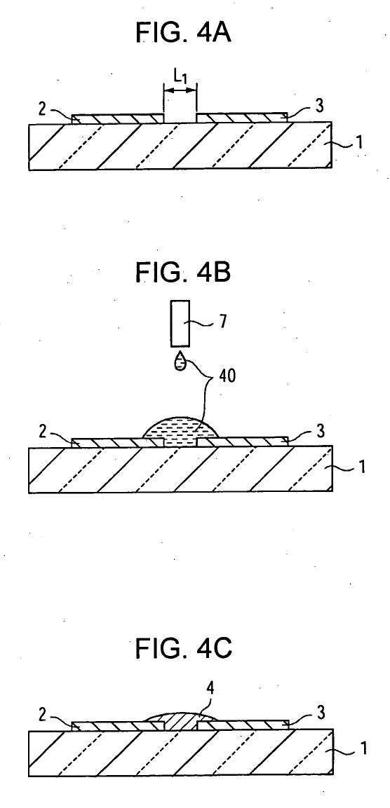

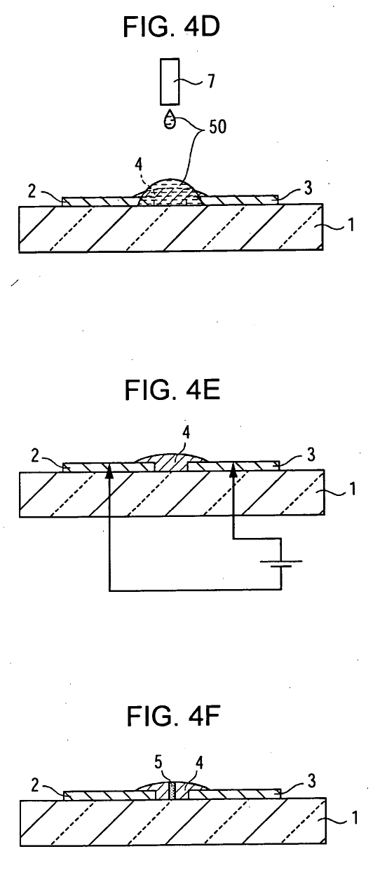

Hereinafter, a method of manufacturing the electron emission element according to an embodiment of the invention will be described in detail with reference to FIGS. 2 to 5. FIG. 2 is a flow chart illustrating a method of manufacturing the electron emission element, FIG. 3 is a schematic perspective view illustrating a structure of a droplet discharge head, FIGS. 4A to 4C and 5D to 5F are schematic cross-sectional views illustrating a method of manufacturing the electron emission element corresponding to the flow chart of FIG. 2.

As shown in FIG. 2, the method of manufacturing the electron emission element 10 according to the present embodiment includes an electrode forming process S1 of forming a pair of electrodes 2 and 3 facing each other with a predetermined gab therebetween on the element substrate 1, and a thin film forming process S2 of forming a conductive thin film 4 so as to bridge across the electrodes 2 and 3. In addition, the method further includes an etching process S4 that partially removes the conductive thin film 4. In addition, the method further includes an electrifying process S5 that electrically connects between the element electrodes 2 and 3 to form the electron emission section 5 in the conductive thin film 4. In addition, the thin film forming process S2 has a process S3 that dries and bakes the functional solution containing the conductive thin film formation material discharged on the element substrate 1 to make it thinner.

Step S1 of FIG. 2 is an electrode forming process. In step S1, the element electrodes 2 and 3 are spaced apart from each other by a predetermined gap L₁ and face each other on the element substrate 1 as shown in FIG. 4A. In this case, the method of forming the electrode may include a method that a film is formed on the surface of the element substrate 1 using the above-described material by means of a vacuum deposition method or a sputtering method to be patterned by using a photolithographic method, or a method that a paste type material is patterned by a print method and then baked. Thereafter, the procedure proceeds to step S2.

Step S2 is a thin film forming process. In step S2, as shown in FIG. 4B, the functional solution 40 containing the above-described conductive thin film formation material is discharged as a droplet to bridge across the element electrodes 2 and 3. Then, the procedure proceeds to step S3. In addition, a method of discharging the functional solution 40 as the droplet, employs the droplet discharge device (not shown) including a droplet discharge head 7 which is capable of discharging the functional solution 40 as droplets and a scanning device which is capable of moving the droplet discharge head 7 and/or the element substrate 1 so as to make the droplet discharge head 7 face the element substrate 1.

Hereinafter, the droplet discharge head 7 will be described. The droplet discharge head 7 is formed such that a nozzle plate 30 having a plurality of nozzles 31 for discharging the droplet, a cavity plate 32 having cavities 34 communicating with the individual nozzles 31 and a vibration plate 37 having vibrators 38 corresponding to the plurality of cavities 34 are sequentially stacked to be bonded to each other as shown in FIG. 3.

The cavity plate 32 has the plurality of cavities 34 divided by partition walls 33 and a reservoir 36 connected to the cavities 34 via flow paths 35.

The functional solution 40 is supplied from a supply source (not shown) via a pipe, is stored in the reservoir 36 through the supply hole 39 formed in the vibration plate 37 and then charged in the cavities through the flow path 35.

The vibrator 38 is, for example, a piezo-element, and vibrates the bonded vibrating plate 37 when a driving voltage is applied from the outside. Accordingly, volumes of the cavities partitioned by the partition wall 33 are changed to press the functional solution 40 charged in the cavities 34, so that the vibrator allows the functional solution 40 to be discharged from the nozzles 31 as droplets.

Step S3 is a drying and baking process that dries and bakes the discharged functional solution 40. In step S3, as shown in FIG. 4C, the functional solution 40 bridged across the element electrodes 2 and 3 are heated by a heating device (not shown), and then dried and baked to form the conductive thin film 4. The drying and baking process may use the droplet discharge device including a heater such as a lamp anneal unit to heat the element substrate 1 discharged with the functional solution 40. In addition, the element substrate 1 discharged with the functional solution 40 may be put into a dry furnace to be dried and baked. Then, the procedure proceeds to step S4.

Step S4 is an etching process that removes a part of the conductive thin film 4. In step S4, as similar to step S2, an etchant 50 is discharged from the droplet discharge head 7 as droplets to two sides of the conductive thin film 4 in an area bridging across the element substrates 2 and 3 as shown in FIG. 4D. In this case, the etchant 50 is discharged so as to be landed and spread on the droplet discharge region 6 as shown in FIG. 1A. By doing so, the conductive thin film 4 has a narrow region in which a portion of the conductive thin film is etched to be circular arcs corresponding to the spread etchant 50 to face the arced sides each other and one of the sides is close to the other sides. Further, in this case, the width L₃ (See FIG. 1B) of the narrow region is etched so as to be smaller than the width L₂ (See FIG. 1A) of the direction orthogonal to the direction where the element electrodes 2 and 3 face each other. The etchant 50 may use an inorganic acid, an organic acid or an inorganic alkali solution or an organic alkali solution, depending on the material used as the conductive thin film 4. For example, when In₂O₃ is used as the conductive thin film 4, an inorganic acid in which nitric acid and hydrochloric acid are mixed at a ratio of 1:3, or a hydrochloric acid aqueous solution of ferric chloride may be employed to carry out etching. Then, the procedure is progressed to step S5.

Step S5 is an electrifying process which is an electron emission section forming of forming the electron emission section 5 in the conductive thin film 4. In step S5, the element electrodes 2 and 3 are electrically connected as shown in FIG. 4E. In order to electrically connect the electrodes, a triangular pulse wave having a predetermined pulse value is applied between the element electrodes 2 and 3 for several seconds to several tens of minutes at a constant time interval under a vacuum atmosphere of about 10⁻⁵ Torr (10⁻⁵ N/m²). By doing so, the conductive thin film 4 has a high resistance in the narrow region, so that the narrow region can be locally broken, deformed, or changed due to the electrical connection, which thus leads to formation of the deformed electron emission section 5 as shown in FIG. 4F. Alternatively, as another method of electrically connecting the electrodes, a wave with a changed waveform or pulse height may be applied in consideration of material and thickness of the conductive thin film 4. In addition, in order to stabilize an element current I_{f} and an emission current Iₑ by depositing new carbon or carbon compound on the electron emission element 10 after electrically connecting the electrodes, well known activation processing and stabilization processing may be carried out under a vacuum atmosphere.

According to the above-described manufacturing process, the electron emission element 10 having the electron emission section 5 at the position corresponding to the narrow region of the conductive thin film 4 bridging across the element electrodes 2 and 3 can be manufactured.

Image Display Device and Method of Manufacturing the Same

Hereinafter, an image display device and a method of manufacturing the image display device according to an embodiment of the invention will be described with reference to FIGS. 5A and 5B. FIG. 5A is a schematic cross-sectional view illustrating a main structure of the image display device, and FIG. 5B is a schematic plan view illustrating an arrangement of the electron emission element on the element substrate.

As shown in FIG. 5A, an image display device 20 includes an element substrate 1 on which electron emission elements 10 are arranged and a display substrate 21 facing the element substrate 1.

As shown in FIG. 5B, first signal lines 13 and second signal lines 14 are arranged in a matrix on the element substrate 1. First element electrodes 11 corresponding to the above-described element electrodes 2 are formed to protrude from the first signal lines 13, and second element electrodes 12 corresponding to the above-described element electrodes 3 are formed protrude from the second signal lines 14, so that the electron emission elements 10 having the first and second electrodes are disposed in a unit of pixel. Accordingly, the element substrate 1 has a simple matrix type element arrangement.

Interlayer insulating films 15 formed of an insulating material are arranged at intersections between the first signal lines 13 and the second signal lines 14 to insulate the lines. Different signals are applied to the first and second signal lines 13 and 14, respectively. That is, scan signals for sequentially driving the electron emission elements 10 one by one (parallel to the X axis of the drawing) are applied to the first signal lines 13, and gradation signals for controlling electron emission of the electron emission elements 10 at the row selected by the scan signal are applied to the second signal line 14 so that the electron emission is controlled in the unit of pixels.

A method of manufacturing the element substrate 1 including such electron emission elements 10 is carried out by a method of manufacturing the above-described electron emission element 10. The first signal lines 13 having the first element electrodes 11 are formed at a position corresponding to the electron emission element 10 arranged on the element substrate 1 such that a film is formed on a surface of the element substrate 1 using the above-mentioned material by means of a vacuum deposition method or a sputtering method and then the film is patterned by a photolithography method, or the material which is a paste type is patterned by means of a print method and then baked. Next, the interlayer insulating films 15 are formed at intersections of the second signal lines 14 and the first signal lines 13.

A method of forming the interlayer insulating film 15 preferably employs a droplet discharge method which applies the functional solution containing the insulating material onto the first signal lines 13 as droplets, and then dries and bakes to form the interlayer insulating films 15. By doing so, the insulating material can be prevented from being wasted and the interlayer insulating films 15 can be formed at desired positions. In addition, a phase type insulating material may be printed at a predetermined position by the print method and then dried and baked to form the interlayer insulating film.

Next, the second signal lines 14 including the second element electrodes 12 are formed. The forming method is same as that of the first signal lines 13. Further, the functional solution 40 containing the conductive thin film formation material is applied as droplets between the first and second element electrodes 11 and 12 and then dried and baked to form the conductive thin film 4. Subsequently, the etchant 50 is applied as droplets to be bridged across the conductive thin film 4, so that the narrow region where arced sides face each other is formed. In addition, based on the electrifying process, the first and second signal lines 13 and 14 are electrically connected to each other so that the electron emission section 5 is formed in the narrow region of the conductive thin film 4. Accordingly, the element substrate 1 is manufactured in which the electron emission elements 10 are arranged in a matrix and the thickness of the conductive thin film 4 in the peripheral region of the electron emission section 5 is more uniform.

The display substrate 21 includes a counter electrode 23, a fluorescent substance 24, and a light shielding layer 25. An accelerating voltage (e.g. 10 kV) is applied to the counter electrode 23, which gives a sufficient energy sufficient for exciting the fluorescent substance 24, so that it acts to accelerate the emitted electrons. The counter electrode 23 is formed by attaching a transparent conductive film such as Indium Tin Oxide (ITO).

The light shielding layer 25 is formed to correspond to the arrangement of the electron emission element 10 so as to partition pixels, and also functions to reduce cross-talk between pixels or reduce external light reflection from the fluorescent substance 24. Examples of the material include materials having conductivity and light shielding property such as graphite. A method of forming the light shielding layer 25 may employ a photolithography method, a print method, and a droplet discharge method.

The fluorescent substance 24 is excited by an impact of electrons emitted from the electron emission element 10 to emit light so that it functions to turn on or off the pixels. When the image display device 20 is a color display type, the fluorescent substance 24 is divided into fluorescent substances corresponding to three primary colors for every pixel. A method of forming the fluorescent substance 24 may employ the droplet discharge method which discharges the functional solution containing the fluorescent formation material to the pixel regions divided by the light shielding layer 25 and then dries it, so that the fluorescent substance 24 can be formed without wasting the fluorescent formation material.

In the image display device 20, the element substrate 1 including the electron emission elements 10 and the display substrate 21 including the fluorescent substance 24 are spaced apart from each other by a predetermined gap by an external frame (not shown), and a space 22 between the substrates 1 and 21 is sealed at a vacuum state of 10⁻⁷ Torr (10⁻⁷ N/m²). In addition, in order to keep the degree of vacuum, a gas absorbing layer (not shown) may be formed on the surface facing the space 22 by a deposition method.

According to the above-described structure, the scan signals applied to the first signal lines 13 and the gradation signals applied to the second signal lines 14 are controlled, so that electrons are emitted from the electron emission elements 10, and the emitted electrons which is accelerated in the counter electrode 23 impact the fluorescent substance 24 to turn on the pixels, so that a desired image is displayed. Since the image display device 20 has the above-described electron emission elements 10, the thickness of the conductive thin film 4 in the peripheral region of the electron emission section 5 becomes more uniform, and relative positional relationship between the electron emission section 5 and the fluorescent substance 24 is stabilized. Accordingly, the image can be displayed which has a stable electron emission property as well as a high display quality with reduced luminance irregularity.

Electronic Apparatus

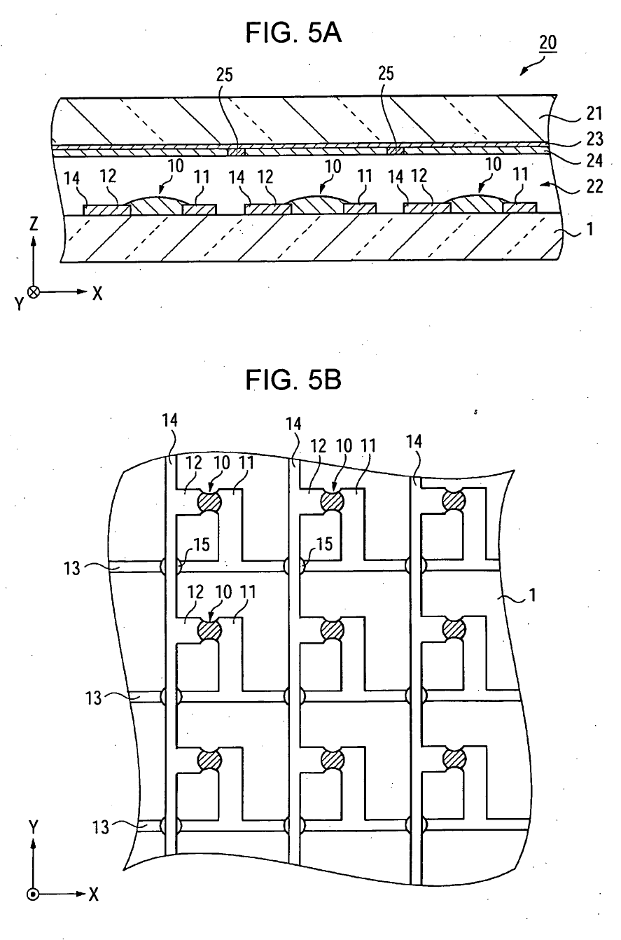

Hereinafter, an electronic apparatus according to an embodiment of the invention will be described with reference to FIG. 6. FIG. 6 is a schematic perspective view illustrating a portable information processing device as the electronic apparatus.

As shown in FIG. 6, the portable information processing device 100 as the electronic apparatus includes a keyboard 101, a main body of the portable information processing device 103, and a display unit 102. The image display device 20 having the above-described electron emission elements 10 is mounted in the display unit 102 of the portable information processing device 100. Specific examples of such portable information processing device 100 include a word processor, and a personal computer.

In addition, other examples of the electronic apparatus including the electron emission elements 10 include, various apparatuses using the electron emission elements 10 as coherent electronic sources, e.g., a coherent electron beam focusing apparatus, an electron line holographic apparatus, a monochromic electron gun, an electron microscope, an apparatus of forming a plural coherent electron beams, an electron beam exposure apparatus, a lithography apparatus of an electrophotographic printer, and so forth.

Effects of the above-described embodiments are as follows.

(1) According to the electron emission element 10 of the present embodiment, the electron emission section 5 is formed in the narrow region where two arced sides of the conductive thin film 4 bridging across the element substrates 2 and 3 face each other. Therefore, even though the variation in the thickness is generated in the peripheral region of the electron emission section 5, it is possible to reduce the variation of the thickness of the side of the conductive thin film 4 by forming the narrow region. In addition, since the width L₃ of the narrow region is smaller than the width L₂ of the element electrodes 2 and 3, the narrow region has the highest resistance at the time of electrically connecting the electrodes, and the electron emission section 5 is formed at a position corresponding to the narrow region of the conductive thin film 4. Accordingly, the variation of the electron emission due to non-uniformity of the conductive thin film 4 can be reduced to have a stable electron emission property while the electron emission element 10 the electron emission section 5 which is formed at the stable position corresponding to the narrow region of the conductive thin film 4 can be provided.

(2) According to the method of manufacturing the electron emission element 10 of the present embodiment, since the etchant 50 applied over two sides of the conductive thin film 4 bridging across between the element electrodes 2 and 3 are landed to be approximately circular due to the surface tension to etch the conductive thin film 4, it is possible to remove the facing sides of the conductive thin film 4 to be circular arcs. Accordingly, the arced sides of the conductive thin film 4 face each other and a part of one side is close to the other side to form a narrow region with a high resistance. The element electrodes 2 and 3 are electrically connected to each other in the electrifying process, so that the electron emission section 5 can be easily formed in the narrow and high resistance region. In addition, the sides of the conductive thin film 4 can be etched to have circular arcs by a more simplified method than the method of etching the conductive thin film 4 by means of a photographic method.

(3) According to the method of manufacturing the electron emission element 10, the thin film forming process in step S2 allows droplets of the functional solution 40 containing the conductive thin film formation material to be dropped between the element electrodes 2 and 3 from the droplet discharge head 7 to form the conductive thin film 4. Therefore, it is possible to form the conductive thin film by an easier method as compared to the method of forming the conductive thin film 4 by using the vacuum such as a deposition method or a sputtering method. In addition, by combining with a method of discharging the etchant 50 as the droplets from the droplet discharge head 7 to form the conductive thin film 4, it is further possible to continuously perform from the thin film forming step to the etching step by using the droplet discharge head. As a result, it is possible to effectively manufacture the element emission element 10 at low cost.

(4) Since the image display device 20 of the present embodiment includes the electron emission element 10, the thickness of the conductive thin film 4 in the peripheral region of the electron emission section 5 is more uniform, and relative positional relationship between the electron emission section 5 and the fluorescent substance 24 is stabilized. Accordingly, it is possible to display an image having a stable electron emission property and a high display quality with reduced luminance irregularity.

(5) Since a method of manufacturing the image display device 20 of the present embodiment uses the above mentioned method of manufacturing the electron emission element 10, it is possible to manufacture the image display device 20 including the electron emission element 10 having the electron emission section 5 formed at a stable position while having a stable electron emission property. Accordingly, the fluorescent substance 24 stably emits light by means of electrons emitted from the electron emission element 10, so that it is possible to manufacture the image display device 20 having a high display quality and reduced display defects such as luminance irregularity.

(6) Since the portable information processing device 100 as the electronic apparatus of the present embodiment has the image display device 20 in the display unit 102, it is possible to provide the portable information processing device 100 which can display and check information such as input and output images with a high display quality and reduced luminance irregularities.

In addition, modified embodiments other than the above-described embodiments are as follows.

### First Modified Embodiment

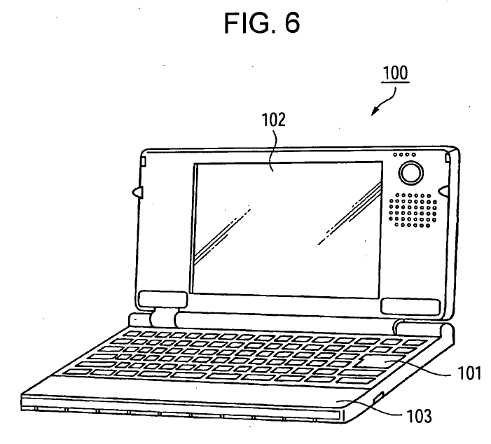

In the electron emission element 10 and the method of manufacturing the same, the electron emission section 5 formed in the narrow region where arced sides of the conductive thin film 4 are close to and face each other, may not necessarily be formed in the direction orthogonal to the direction where the element electrodes 2 and 3 face each other. FIG. 7 is a schematic plan view illustrating the electron emission element of the modified embodiment. As shown in FIG. 7, according to the electron emission element 60 of the modified embodiment, element electrodes 62 and 63 face each other with a predetermined gap L₁ therebetween on an element substrate 61, and the functional solution 40 is discharged from the droplet discharge head 7 to bridge across the element electrodes 62 and 63 to form a conductive thin film 64. Then, an etchant 50 is discharged from the droplet discharge head 7 onto regions 66 and 67 bridging across two sides of the conductive thin film 64 to be landed and spread to etch a narrow region having a width L₃. In addition, when electrically connecting between the element electrodes 62 and 63 in the electrifying process, it is possible to form the inclined electron emission section 65 in an inclined direction with respect to the facing direction of the element electrodes 62 and 63. Accordingly, it is further possible to adjust a position where the electron emission section 5 is formed in consideration of the direction where the electrons are emitted. Further, in this case, the width L₃ of the narrow region is smaller than the width L₂ of the element electrodes 62 and 63.

### Second Modified Embodiment

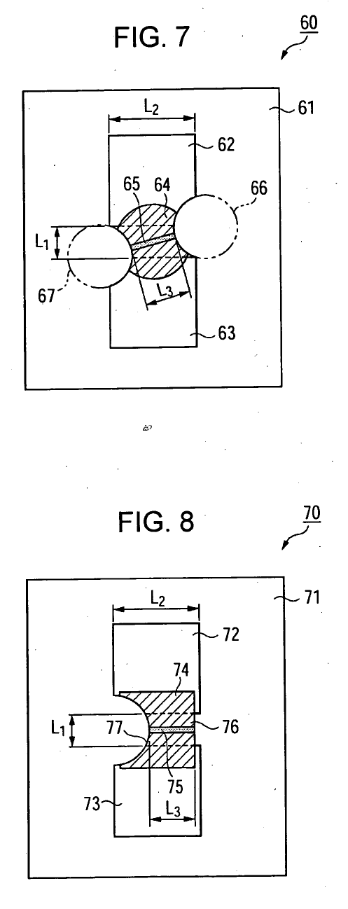

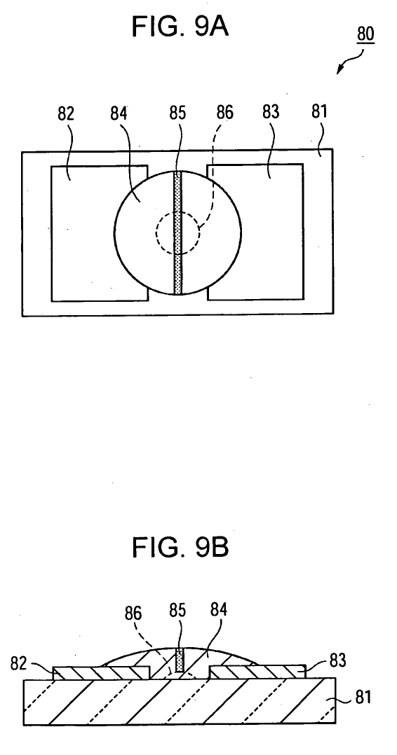

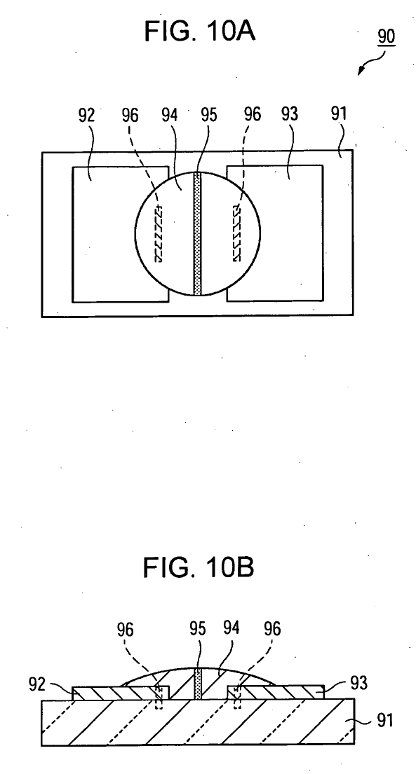

In the electron emission element 10 and the method of manufacturing the same, the shape of the conductive thin film 4 having the narrow region and the method of forming the same are not limited thereto. FIG. 8 is a schematic plan view illustrating the electron emission element of the modified embodiment. In the electron emission element 70 of the modified embodiment shown in FIG. 8, element electrodes 72 and 73 are spaced apart from each other by a predetermined gap L₁ on an element substrate 71, and a conductive thin film formation material is bridged across the element electrodes 72 and 73. And a conductive thin film 74 is formed such that one side 77 is made to be a circular arc by a photolithographic method, and the other side 76 is made to be straight. By doing so, even though the process becomes complicated as compared to the case of etching the conductive thin film 4 by a droplet discharge method, the narrow region having a width L₃ can be accurately formed at any position with respect to the straight side 76 while an electron emission section 75 can be formed in the narrow region. Alternatively, the side 77 may not necessarily have the circular arc. For example, the narrow region may be formed such that the side 77 may be etched to have a wedge shape. Further, in this case, the width L₃ of the narrow region is smaller than the width L₂ of the element electrodes 72 and 73.

### Third Modified Embodiment

In the method of manufacturing the electron emission element 10, process orders are not limited thereto. For example, the process of forming the element electrodes 2 and 3 may be carried out after the process of partially etching the conductive thin film 4. Accordingly, parts of the element electrodes 2 and 3 are not etched while partially etching the conductive thin film 4.

What is claimed is:

1. An electron emission element, comprising:
a pair of electrodes facing each other with a predetermined gap therebetween;
a conductive thin film which bridges across the electrodes and has a narrow region in which a part of at least one side of two sides of an area bridging across the electrodes is close to the other side; and
an electron emission section formed in the narrow region of the conductive thin film,
wherein the narrow region is narrower than the width between the electrodes in a direction orthogonal to a direction where the electrodes face each other.

2. The electron emission element according to claim 1, wherein the conductive thin film has the narrow region in which the at least one side of two sides of the area bridging across the electrodes has a circular arc and the part of the arced side is close to the other side.

3. A method of manufacturing an electron emission element, comprising:
forming a pair of electrodes facing each other with a predetermined gap therebetween on a substrate;
forming a conductive thin film so as to bridge across the electrodes;
partially removing the conductive thin film so that a part of at least one side of two sides of the conductive thin film in an area bridging across the electrodes has a circular arc and a narrow region in which the part of the arced side is close to the other side is narrower than the width between the electrodes in a direction orthogonal to a direction where the electrodes face each other; and
electrically connecting between the electrodes to form an electron emission section in the conductive thin film.

4. The method according to claim 3, wherein the removing of the conductive thin film includes etching the conductive thin film by discharging an etchant to the at least one side of two sides of the conductive thin film in the area bridging across the electrodes.

5. The method according to claim 3, wherein the forming of the conductive thin film includes discharging a functional solution containing a conductive thin film formation material to form the conductive thin film.

6. An image display device, comprising:
an electron emission element according to claim 1; and
a fluorescent substance that receives electrons emitted from the electron emission element to emit light.

7. A method of manufacturing an image display device including an electron emission element and a fluorescent substance that receives electrons emitted from the electron emission element to emit light, comprising:
manufacturing the electron emission element by a method according to claim 3.

8. An electronic apparatus comprising an image display device according to claim 6.
